(19) United States
(12) Patent Application Publication
(10) Pub. No.: US 2013/0141675 A1
(43) Pub. Date: Jun. 6, 2013

(54) LIQUID CRYSTAL DISPLAY DEVICE

(71) Applicants: INNOCOM TECHNOLOGY (SHENZHEN) CO., LT, Shenzhen City (CN); CHIMEI INNOLUX CORPORATION, Chu-Nan (TW)

(72) Inventors: Chih-Yung HSIEH, Chu-Nan (TW); Chien-Hung CHEN, Chu-Nan (TW)

(73) Assignees: CHIMEI INNOLUX CORPORATION, Chu-Nan (TW); INNOCOM TECHNOLOGY (SHENZHEN) CO., LTD., Shenzhen City (CN)

(21) Appl. No.: 13/686,846

(22) Filed: Nov. 27, 2012

Related U.S. Application Data
(60) Provisional application No. 61/566,575, filed on Dec. 2, 2011.

(51) Int. Cl. G02F 1/1335

(52) U.S. Cl. CPC G02F 1/133533
USPC 349/96

(57) ABSTRACT

A liquid crystal display device is provided. The liquid crystal display device includes a first substrate having a pixel unit, wherein the pixel unit has a pixel electrode. A second substrate is disposed opposite to the first substrate, having an opposite electrode. A first polarizer is disposed under the first substrate. A second polarizer is disposed under the second substrate, wherein a polarization axis of the second polarizer is vertical to that of the first polarizer. A liquid crystal layer with chiral dopants having negative dispersion characteristics is disposed between the first and second substrates.

### CROSS REFERENCE TO RELATED APPLICATIONS

This application claims the benefit of U.S. Provisional Application No. 61/566,575 filed on Dec. 2, 2011, the entirety of which is incorporated by reference herein.

### BACKGROUND OF THE INVENTION

1. Field of the Invention

The present invention relates to a liquid crystal display device, and in particular, to a liquid crystal display device having a high-transmittance characteristic.

2. Description of the Related Art

The transmittance of a liquid crystal (LC) display device can be modified due to different polarizations or diffractions of an incident light by changing arrangements of liquid crystal molecule, so that the LC display can produce images. The conventional twisted nematic (TN) device has good transmittance performance. However, the conventional TN device has a very narrow viewing-angle, which is limited by the structure and optical characteristics of liquid crystal molecules. Therefore, it is a challenge for the LC display to have both a wide-viewing-angle and high utilization of light characteristics.

A vertical alignment (VA) type wide-viewing-angle LC display has been developed to solve the aforementioned problems. The VA type LC display comprises a patterned vertical alignment (PVA) type LC display, a multi-domain vertical alignment (MVA) type LC display, and etc.. The PVA type LC display achieves the goal of wide-viewing-angle characteristics by applying a fringing-field effect and optical compensation films. The MVA type LC display widens an LC display's viewing-angle and improves transmittance by dividing a pixel area into multi domains and tilting liquid crystals respectively in the multi domains in several different directions using protrusion features or specific indium tin oxide (ITO) patterns.

Thus, a novel VA type liquid crystal display device with an improved high-transmittance characteristic is desired to improve the aforementioned problems.

### BRIEF SUMMARY OF INVENTION

A liquid crystal display is provided. An exemplary embodiment of a liquid crystal display device comprises a first substrate having a pixel unit, wherein the pixel unit has a pixel electrode. A second substrate is disposed opposite to the first substrate, having an opposite electrode. A first polarizer is disposed under the first substrate. A second polarizer is disposed under the second substrate, wherein a polarization axis of the second polarizer is vertical to that of the first polarizer. A liquid crystal (LC) layer with chiral dopants having negative dispersion characteristics is disposed between the first and second substrates.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a cross sectional view showing one exemplary embodiment of a liquid crystal device of the invention.

FIG. 2 is a top view showing one exemplary embodiment of electrode patterns of a liquid crystal device of the invention.

FIG. 3a is a side view showing one exemplary embodiment of vertical alignment type liquid crystal molecules of one exemplary embodiment of a liquid crystal device of the invention without an applied electronic field.

FIG. 3b is a side view showing one exemplary embodiment of vertical alignment type liquid crystal molecules of one exemplary embodiment of a liquid crystal device of the invention with an applied electronic field.

FIG. 4a is a transmittance diagram showing a liquid crystal device formed by a liquid crystal material without chiral dopants.

FIG. 4b is a transmittance diagram showing a liquid crystal device formed by a liquid crystal material with chiral dopants.

FIGS. 5a to 5c are transmittance distribution diagrams corresponding to different parameters of the optical path difference (Δnd)) and LC rotations (d/p ratio) of one exemplary embodiment of a liquid crystal (LC) device of the invention, which comprises a LC layer with chiral dopants, for red (the wavelength range is about 450±30 nm), green (the wavelength range is about 550±30 nm) and blue (the wavelength range is about 650±30 nm) incident lights, respectively

### DETAILED DESCRIPTION OF INVENTION

The following description is of a mode for carrying out the invention. This description is made for the purpose of illustrating the general principles of the invention and should not be taken in a limiting sense. The scope of the invention is best determined by reference to the appended claims. Wherever possible, the same reference numbers are used in the drawings and the descriptions to refer the same or like parts.

The present invention will be described with respect to particular embodiments and with reference to certain drawings, but the invention is not limited thereto and is only limited by the claims. The drawings described are only schematic and are non-limiting. In the drawings, the size of some of the elements may be exaggerated and not drawn to scale for illustrative purposes. The dimensions and the relative dimensions do not correspond to actual dimensions to practice the invention.

Embodiments provide a liquid crystal (LC) display device with improved wide-viewing-angle and high-transmittance characteristics. an LC material with chiral dopants is used as an LC layer of one embodiments of an LC display device of the invention.

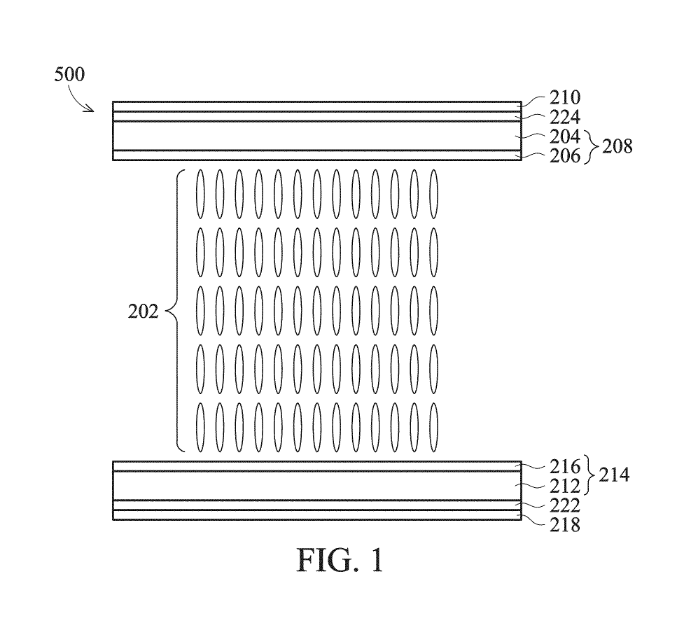

FIG. 1 is a cross sectional view showing one exemplary embodiment of a liquid crystal (LC) device 500 of the invention. One exemplary embodiment of an LC device 500 is a vertical alignment (VA) type LC device. As shown in FIG. 1 the LC device 500 comprises a first substrate 214 and a second substrate 208. The second substrate 208 is disposed opposite to the first substrate 214 and substantially parallel to the first substrate 214. In one embodiment, the first substrate 214 may serve as a thin film transistor (TFT) substrate, comprising a base 212, at least one pixel unit. The pixel unit has a pixel electrode 216 and a TFT (not shown) disposed on the base 212. In one embodiment, the base 212 may comprise a glass substrate. Additionally, black matrixes (not shown) may be disposed between the pixel units.

The second substrate 208 may serve as a color filter (CF) substrate, comprising a base 204, an opposite electrode 206 and color filters (not shown). Additionally, black matrixes (not shown) may be disposed between the color filters.

The LC device 500 further comprises a first polarizer 218 and a second polarizer 210. The first polarizer 218 is disposed under the first substrate 214, and the second polarizer is disposed above the second substrate 208. In one embodiment, a polarization axis of the second polarizer 210 is vertical to that of the first polarizer 218. In one embodiment, the LC device 500 further comprises a first compensation film 222 disposed between the first substrate 214 and the first polarizer 218, and a second disposed between the second substrate 208 and the second polarizer 210.

As shown in FIG. 1, an LC layer 202 of the LC device 500 is disposed between the first substrate 214 and the second substrate 208. In one embodiment, liquid crystal (LC) molecules of the LC layer 202 are formed by a nematic LC material, for example, a negative nematic LC or a positive nematic LC. Also, the LC layer 202 is added materials having the optical activity, for example, chiral dopants. Therefore, the LC molecules of the LC layer 202 may twist along an axis direction, thereby having the optical activity, and the axis direction is parallel to a normal line of the first substrate 214.

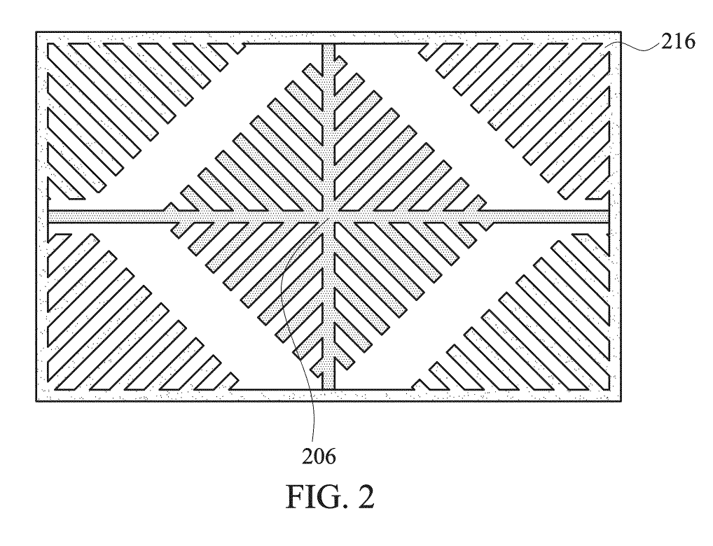

FIG. 2 is a top view showing one exemplary embodiment of electrode patterns of a liquid crystal device of the invention. FIG. 2 illustrates electrode unit patterns of the pixel electrode 216 on the first substrate 214 (TFT side) and the opposite electrode 206 on the second substrate 208 (CF side).

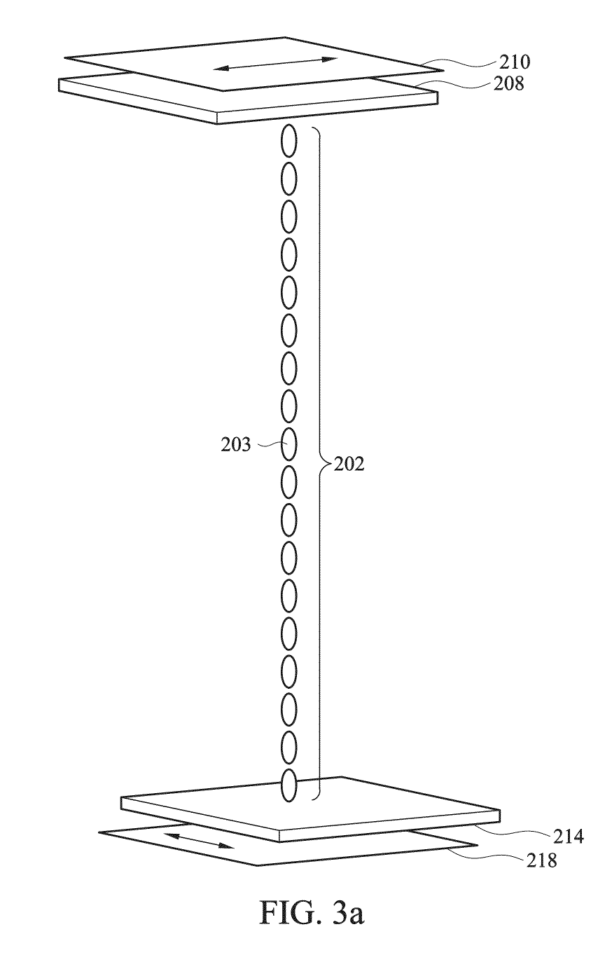

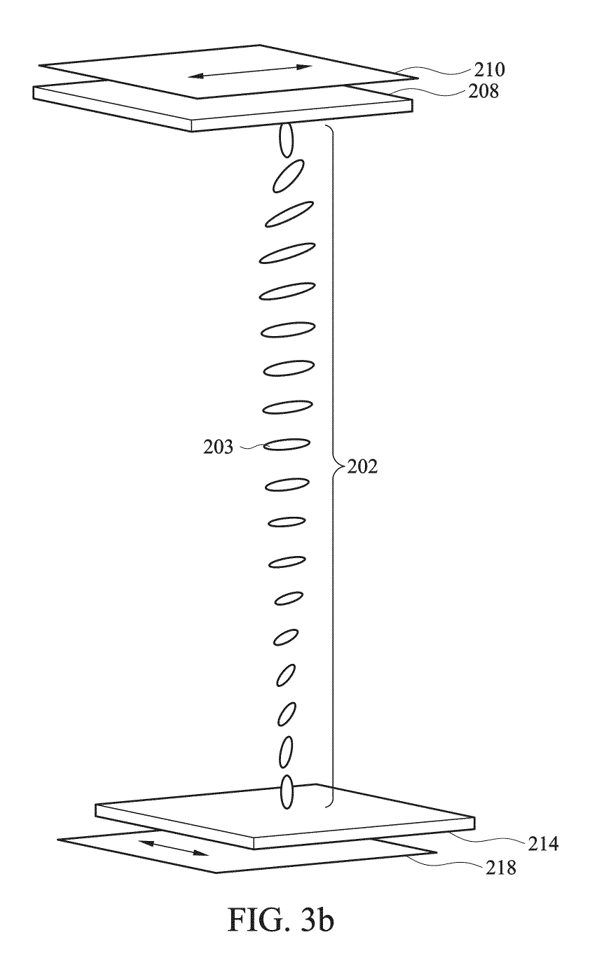

FIG. 3a is a side view of showing one exemplary embodiment of liquid crystal molecules 203 of the LC layer 202 of the liquid crystal device 500 of the invention without an electronic field applied between the first substrate 214 and the second substrate 208. Directions of arrows on the first polarizer 218 and the second polarizer 210 illustrate directions of the polarization axis of the first substrate 214 and the second substrate 208, respectively. FIG. 3b is a side view of showing one exemplary embodiment of liquid crystal molecules 203 of the LC layer 202 of the liquid crystal device 500 of the invention with an electronic field applied between the first substrate 214 and the second substrate 208. As shown in FIG. 3b, the LC molecules 203 are gradually twisted from the first substrate 214 to the second substrate 208, and the LC molecules 203 are gradually tilted to be arranged along a horizontal direction and then the LC molecules 203 are tilted from the horizontal direction to along a vertical direction. Along with increasing the applied electronic field, a range of the LC molecules 203 tilted to be a horizontal arrangement is increased. The twist angle of the LC molecules can be defined by controlling the concentration of chiral dopants. If a thickness of the LC layer is represented as d, a pitch of chiral dopants is represented as p, and a parameter of LC rotations is represented as d/p ratio.

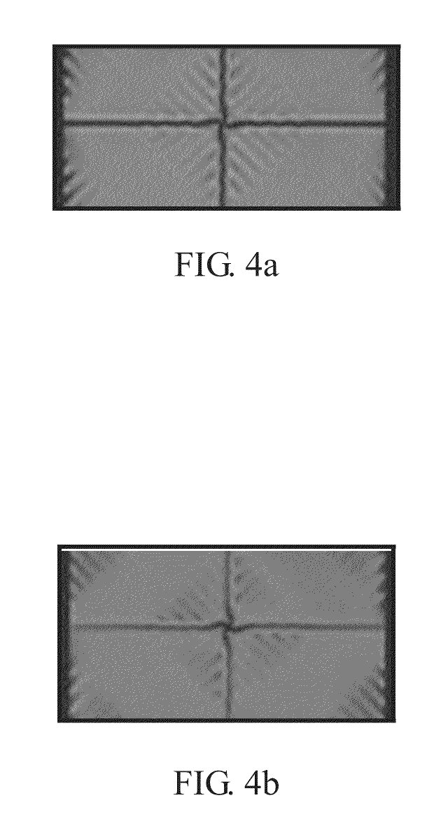

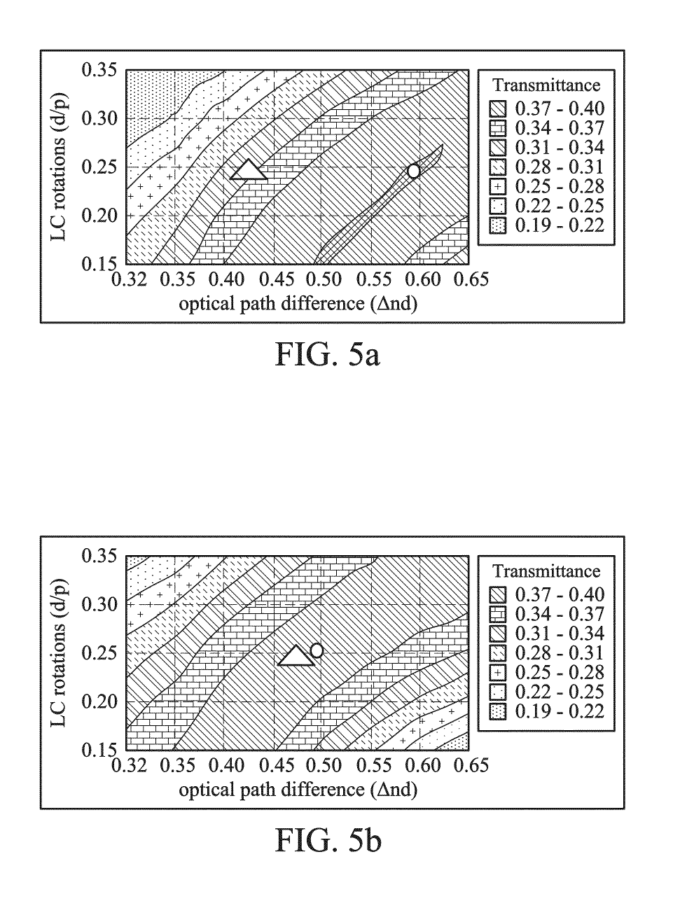

FIG. 4a is a transmittance diagram showing a liquid crystal device formed by a liquid crystal material without chiral dopants. FIG. 4b is a transmittance diagram showing one exemplary embodiment of a liquid crystal device formed by a liquid crystal material with chiral dopants. Electrode patterns of the liquid crystal devices as shown in FIGS. 4a and 4b are the same to the electrode patterns as shown in FIG. 2. As shown in FIGS. 4a and 4b, because the LC molecules with chiral dopants can result in a macroscopic helical twist, the optical dark lines, which result from the non-tilting or tilting error problems of the LC molecules, in the display area of the liquid crystal device as shown in FIG. 4a are thinner and lighter than the optical dark lines as shown in FIG. 4b. Therefore, the liquid crystal device has the high-transmittance characteristic.

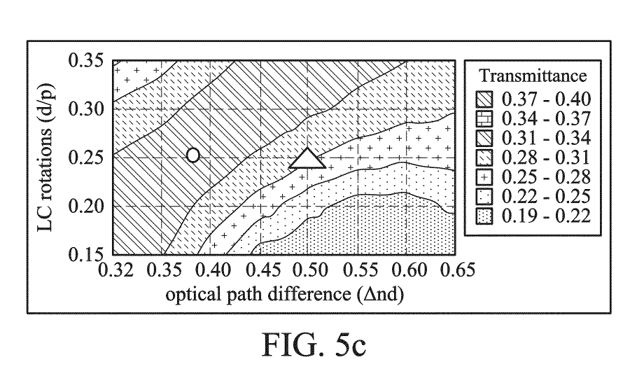

The liquid crystal device may have different transmittance distributions for incident lights with different wavelengths. FIGS. 5a to 5c are transmittance distribution diagrams corresponding to different parameters of the optical path difference (Δnd) and LC rotations (d/p ratio) of one exemplary embodiment of a liquid crystal (LC) device 500 of the invention, which comprises a LC layer with chiral dopants, for red (the wavelength range is about 450±30 nm), green (the wavelength range is about 550±30 nm) and blue (the wavelength range is about 650±30 nm) incident lights, respectively, wherein the applied voltage of the liquid crystal device is about 7 volt, the viewing-angle of the liquid crystal device is zero degree, Δn is the birefringence coefficient of the LC layer with chiral dopants (also referred to as refractive index differences between the fast axis and slow axis of the LC layer with chiral dopants), d is a thickness of the LC layer with chiral dopants, λ is a wavelength of an incident light. In this embodiment, the liquid crystal device 500 is operated by an incident light having a wavelength between 380 nm and 780 nm. Also, the birefringence coefficient Δn of the LC layer with chiral dopants of the conventional liquid crystal device for red, green and blue incident lights are about 0.125, 0.115 and 0.105, and the thickness of the LC layer with chiral dopants of the conventional liquid crystal device is designed of about 4 νm. Therefore, the transmittance values of the conventional liquid crystal device corresponding to the designed optical path difference (Δnd)) and the optimized value of LC rotations (d/p ratio) for red (the wavelength range is about 650±30 nm), green (the wavelength range is about 550±30 nm) and blue (the wavelength range is about 450±30 nm) incident lights are respectively labeled as triangular spots in FIGS. 5a to 5c. In one embodiment, the optimized value of LC rotations (d/p ratio) is between 0.2 and 0.3. In this embodiment, the optimized value of LC rotations is about 0.25. It is noted that the transmittance values of the conventional liquid crystal device for red, green and blue incident lights can not meet the goal of high transmittance.

To improve the transmittance of the liquid crystal device for incident light in different wavelength ranges, the LC layer with chiral dopants of the liquid crystal device 500 may be designed having negative dispersion characteristics. The negative dispersion characteristics are defined as a first differential of a refractive index (n) of the LC layer with chiral dopants with respect to the wavelength (λ) of an incident light is larger than zero (That is to say, dn/dλ>0). Therefore, when the wavelength of the incident light is increased, parameters of the refractive index (n) or the refractive index differences (Δn) between the fast axis and slow axis of the LC layer with chiral dopants is also increased. Circular spots shown in FIGS. 5a to 5c illustrate that the transmittance of the liquid crystal device 500 using the LC layer with chiral dopants, which has negative dispersion characteristics, corresponding to the designed value of the optical path difference (Δnd) (0.59 for red, 0.49 for green and 0.38 for blue) and the optimized value of LC rotations (d/p ratio) for red (the wavelength range is about 650±30 nm), green (the wavelength range is about 550±30 nm) and blue (the wavelength range is about 450±30 nm) incident lights, respectively. In one embodiment, the optimized value of LC rotations (d/p ratio) is between 0.2 and 0.3. In this embodiment, the optimized value of LC rotations is about 0.25. It is noted that the transmittance values of the liquid crystal device 500 using the LC layer with chiral dopants, which has negative dispersion characteristics, for red, green and blue incident lights can achieve the highest transmittance value (0.37-0.40).

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A liquid crystal display device, comprising:
a first substrate having a pixel unit;
a second substrate disposed opposite to the first substrate, having an opposite electrode;
a first polarizer disposed under the first substrate;
a second polarizer disposed under the second substrate, wherein a polarization axis of the second polarizer is vertical to that of the first polarizer; and
a liquid crystal (LC) layer with chiral dopants having negative dispersion characteristics disposed between the first and second substrates.

2. The liquid crystal display device as claimed in claim 1, wherein liquid crystal display device is operated by an incident light having a wavelength between 380 nm and 780 nm.

3. The liquid crystal display device as claimed in claim 1, wherein a parameter of LC rotations (d/p ratio) of the LC layer with chiral dopants is between 0.2 and 0.3, wherein d is a thickness of the LC layer with chiral dopants, and P is a pitch of chiral dopants.

4. The liquid crystal display device as claimed in claim 1, wherein a first differential of a refractive index (n) of the LC layer with chiral dopants with respect to the wavelength (λ) of an incident light is larger than zero.

5. The liquid crystal display device as claimed in claim 1, wherein the first substrate is a thin film transistor (TFT) substrate, and the second substrate is a color filter substrate.

6. The liquid crystal display device as claimed in claim 1, wherein the LC layer with chiral dopants is formed by a nematic LC material.

7. A liquid crystal display device, comprising:
a first substrate having a pixel unit:
a second substrate disposed opposite to the first substrate, having an opposite electrode;
a first polarizer disposed under the first substrate;
a second polarizer disposed under the second substrate, wherein a polarization axis of the second polarizer is vertical to that of the first polarizer; and
a liquid crystal (LC) layer with chiral dopants disposed between the first and second substrates, wherein a first differential of a refractive index (n) of the LC layer with chiral dopants with respect to the wavelength (λ) of an incident light is larger than zero.

8. The liquid crystal display device as claimed in claim 7, wherein liquid crystal display device is operated by an incident light having a wavelength between 380 nm and 780 nm.

9. The liquid crystal display device as claimed in claim 7, wherein a parameter of LC rotations (d/p ratio) of the LC layer with chiral dopants is between 0.2 and 0.3, wherein d is a thickness of the LC layer with chiral dopants, and p is a pitch of chiral dopants.

10. The liquid crystal display device as claimed in claim 7, wherein the liquid crystal (LC) layer with chiral dopants having negative dispersion characteristics.

11. The liquid crystal display device as claimed in claim 7, wherein the first substrate is a thin film transistor (TFT) substrate, and the second substrate is a color filter substrate.

12. The liquid crystal display device as claimed in claim 7, wherein the LC layer with chiral dopants is formed by a nematic LC material.
